(19) United States
(12) Patent Application Publication
(10) Pub. No.: US 2025/0384009 A1
(43) Pub. Date: Dec. 18, 2025

(54) METHOD FOR PROCESSING LOG FILES, DATA PROCESSING SYSTEM AND VEHICLE

(71) Applicant: MERCEDES-BENZ GROUP AG, Stuttgart (DE)

(72) Inventor: Sergej REDEL, Wendlingen (DE)

(21) Appl. No.: 18/878,166

(22) PCT Filed: Jun. 21, 2023
(86) PCT No.: PCT/EP2023/066886

§ 371 Date: Dec. 23, 2024

(30) Foreign Application Priority Data
Jul. 5, 2022 (DE) 10 2022 002 450.0

(51) Int. Cl. G06F 16/11

(52) U.S. Cl. CPC G06F 16/116

(57) ABSTRACT

A coding module reads a stream of diagnostic data and generates an encoded log file, which is read by a decoding module to generate a decoded log file. The coding module assigns a version identifier of the used coding instructions used to the header of the encoded log file. The coding module appends a log entry as a payload to the encoded log file when the coding module recognizes in the diagnostic data a log event affecting a particular log parameter for the first time or describing a change in the respective log parameter. The coding module causes the encoded log file to be saved in its current state during system monitoring if the coding module has appended a log entry to the encoded log file or if a predefined period of time has elapsed without appending a further log entry.

### BACKGROUND AND SUMMARY OF THE INVENTION

Exemplary embodiments of the invention relate to a method for processing log files with computer-aided data processing systems, a corresponding data processing system, and a vehicle.

The basic prerequisite for the correct operation of an information technology system is the flawless interaction of hardware and software. Due to a hardware defect or errors in the program code, also referred to as a bug, the correct functioning of an information technology system can be restricted, faulty, or not possible.

For this reason, log files that log the processes executed by the information technology system are generated, particularly during the development of hardware or software components but also during the ongoing operation of an information technology system. Analyzing these log files often makes it possible to find the cause of the error and take appropriate measures to rectify the cause of the error, such as adapting the program code.

The following problems occur in connection with the processing of log files:
1. Depending on the design of the information technology system and the software used to monitor the processes running on the information technology system, also known as a debugger, only incomplete log files are generated after an error occurs, which do not cover all relevant system parameters and/or the entire relevant time period. Often, only the most important parameters are included in a time window close to the error, for example the last minute before the error occurred. A comprehensive problem analysis may then not be possible if the cause of the error can be traced back to a system parameter that was not logged, in particular outside the time window output.
2. Log files can have a large number of system parameters, in particular for long observation periods. Finding a specific system parameter at a specific point in time can then be very labor-intensive. Even the use of search algorithms can often only lead to the desired result after a lengthy search, as an analysis of the system behavior stored and logged in the log file is already required to find a relevant section of the log file. This means that, despite the use of search and/or sorting algorithms, manual effort is required for the user.
3. Log files are often only stored for a running information technology system, for example in a volatile storage medium such as RAM. In the following, “running” or “runtime” refers to the period of time during which a respective information technology system is activated between a boot process and a shutdown process or a crash. The period of time during which the information technology system performs monitoring and saves relevant information in a log file is referred to below as “system monitoring”. During a runtime, one or more system monitoring operations can be performed. If the information technology system shuts down or crashes, the log file for this runtime may also be lost. It is therefore not possible to reconstruct the system status of the Information technology system before the crash.

Methods and devices for generating log files are sufficiently well-known. By way of example, WO 2012/106969 A1 and CN 112286896 A disclose methods and devices for generating and storing log files in a compressed and converted format. This allows corresponding log files to be saved with a lower memory requirement and to be written and read more quickly. A log file can also be converted using cryptographic encryption, which prevents the log file from being processed by unauthorized third parties. However, this does not solve the problems mentioned at the beginning in connection with the processing of log files.

Exemplary embodiments of the present invention are directed to an improved method for processing log files with computer-aided data processing systems and a corresponding data processing system, with the aid of which the problems described above can be at least minimized, but preferably rectified.

In a method for processing log files with computer-aided data processing systems of the type mentioned at the beginning, wherein a log file is generated, processed and/or at least temporarily stored by a data processing system in a coded format and wherein the log file comprises a header and a payload, the following method steps are carried out in accordance with the invention:
reading coding instructions into a coding module;
performing system monitoring and generating a stream of diagnostic data using a diagnostic module during system monitoring;
reading the stream of diagnostic data into a coding module;
generating an encoded log file by applying the coding instructions to the stream of diagnostic data through the coding module;
reading the encoded log file into a decoding module;
reading the coding instructions into the decoding module; and
generating a decoded log file taking into account the coding instructions from the encoded log file through the decoding module; wherein
the coding module assigns a version identifier of the coding instructions used to the header of the encoded log file;
the coding module appends a log entry as a payload to the encoded log file when the coding module recognizes in the diagnostic data a log event that affects a particular log parameter for the first time or that describes a change in the respective log parameter; and
the coding module causes the encoded log file to be saved in its current state during system monitoring if the coding module has appended a log entry to the encoded log file or if a defined period of time has elapsed without appending a further log entry.

The method according to the invention makes it possible to record all log parameters to be logged during system monitoring in the log file and to make the log file available for later analysis purposes even in the event of an unexpected shutdown of the computer-aided data processing system. By saving the log file in the coded version, the individual log entries can be executed in such a way that they can be found particularly quickly and easily in the log file using the coding module. The reduces the manual effort required to evaluate the log file.

A data processing system is an information technology system. One or more computer-aided data processing systems can be involved in processing the log files. By way of example, a first data processing system can be executed by an embedded system. The embedded system can, for example, be integrated into a vehicle such as a car. By way of example, it can be a control unit for controlling a head unit. The diagnostic module then monitors this embedded system, whereby its status is recorded and information processed by the embedded system is output in the form of diagnostic data. The diagnostic module can be part of the embedded system or integrated into an additional data processing system. The additional data processing system can also be part of the vehicle or temporarily connected to the vehicle, for example as a mobile device, such as a tablet computer or laptop, connected to the vehicle via a CAN bus, a USB interface or an Ethernet interface. The coding instructions contain information on how the coding module should process the diagnostic data in order to generate the log file in the coded format. Depending on the design of the data processing system to be monitored and the information being processed or the log parameters to be monitored, the coding instructions can be designed differently. The coding instructions can therefore be described as specific to the data processing system.

The encoded log file is then decoded by means of the decoding module using the same coding instructions. The decoding module can be part of the embedded system or part of an additional data processing system. By way of example, the decoding module is provided by or executed on a developer system. The developer system can be a personal computer, for example. Any of the modules mentioned above can be designed as hardware, software or a combination of hardware and software.

The encoded log file generated by the coding module contains a header and a payload attached to the header. The header comprises a version identifier of the coding instructions used. This allows the decoding module to decide which coding instructions should be used to decode the encoded log file when decoding the encoded log file. The header of the encoded log file thus represents a component of the log file that is designed in the same way independently of the system monitoring. New entries are then appended to the log file by the coding module if it emerges from an analysis of the diagnostic data by the coding module that a new log parameter to be logged provides a value or a changed value for the first time. For this purpose, the coding module recognizes the occurrence of log events in the diagnostic data. Such a log event can also be referred to as a so-called function call. Examples of this are the starting or ending of the data processing system, the loading of a specific software, a change in a sensor value that is recorded and processed by the data processing system, the completion of a task, or similar. The individual log parameters can be any parameters that describe a state of the data processing system or a parameter that describes information processed by the data processing system. Examples of log parameters are a system time, a date, an ignition status of a vehicle, a received signal strength, a speed value, a mass flow, an IP address, or the like.

The encoded log file generated by the coded module can be stored in any data processing system. By way of example, the encoded log file can be stored on a physical storage medium in the same data processing system in which the coding module is also contained, or it can also be transferred from this data processing system to another data processing system. This transfer can be wireless or wired. Any communication technologies such as Ethernet, a USB connection, WiFi, Bluetooth, NFC, ZigBee or similar can be used for this purpose.

The fact that log entries are only appended to the log file as a payload when a log event reveals the first occurrence of a respective log parameter or the change of a corresponding value of the respective log parameter means that the file size of the encoded log file can be kept particularly small. This ensures efficient use of computing resources.

The encoded log file is always saved again when a new log entry is appended to the encoded log file or after the specified time period has elapsed. The specified time period can be selected at will and can be a fixed time interval, for example five milliseconds, one second or five minutes, or an adaptive time period, such as a variable time period depending on a log parameter or log event. By frequently saving the encoded log file, i.e., writing the encoded log file into a persistent storage medium, it can be ensured that the encoded log file is available for further analysis purposes even after an unplanned shutdown or crash of the data processing system.

In particular, the encoded log file is a text file in which the header and the payload are stored as an alphanumeric character string, possibly supplemented by special characters and/or mathematical symbols or similar. The decoding module can then read in the text file and convert it into a different format. By way of example, the decoding module can generate a table from the encoded log file. If individual log parameters appear in the corresponding table for the first time or change, a corresponding cell entry for the log parameter at a specific point in time can be highlighted, for example marked in color. This makes it easier to analyze the log file manually.

An advantageous embodiment of the method provides that
a first encoded log file is at least temporarily stored in the data processing system after its generation during a first system monitoring; and
the coding module concatenates the first encoded log file with the second encoded log file when generating a second encoded log file during a second system monitoring.

This allows two encoded log files to be merged into a single log. This makes it possible to provide the information logged in the previous runtime during the first system monitoring for analysis in the event of a system crash after a restart of the data processing system. In particular, the first encoded log file is stored in the respective data processing system at least during a switch-off time of the data processing system or the diagnostic module and coding module. If the data processing system is then restarted and a second system monitoring is executed during a further runtime, the second encoded log file is generated, wherein the first encoded log file is concatenated with the second encoded log file. Concatenated means, for example, prepending or appending the first encoded log file to the end of the second encoded log file.

According to a further advantageous embodiment of the method, a plurality of differently versioned coding instructions are stored in a first database. The first database can be part of any data processing system. The first database can therefore also be integrated into the same data processing system as the diagnostic module, the coding module, and/or the decoding module. However, the first database can also be provided on a separate data processing system. Such a separate data processing system can be, for example, a server or server network.

New software versions are often created during the development of hardware and/or software components. This can be taken into account by versioning the coding instructions. Depending on the version of the respective hardware or software, the respective appropriately versioned coding instruction can then be used to code and decode the log file. By way of example, the hardware of the data processing system monitored by the diagnostic module can change and/or new parameters such as new sensor data can be processed by the corresponding data processing system. New log parameters to be monitored must therefore be provided. A new version of the coding instructions can thus be generated, which also comprises these new log parameters.

These differently versioned coding instructions can also be executed in a diagnosis module-specific manner.

A further advantageous embodiment of the method according to the invention further provides that a plurality of coding instruction modules are stored in a second database, wherein the data processing system reads at least two coding instruction modules from the second database and combines them to generate a coding instruction. This simplifies the procedure for providing different coding instructions. Depending on the monitored data processing system or the design of the diagnostic module, differently versioned coding instructions can comprise the same modules. These can be stored in the second database, which allows the particularly quick and easy generation of different coding instructions, in particular differently versioned coding instructions. The second database can also preferably be provided on a data processing system designed as a server or server network. This server or server network can then be accessed by programmers, for example, who generate the respective coding instructions for the different data processing systems and diagnostic modules.

According to a further advantageous embodiment
when a specific log parameter is mentioned for the first time by a log event, the coding module appends the value of the log parameter described by the diagnostic data to the encoded log file as a log entry;
before each further appending of a log entry concerning the respective log parameter, the coding module checks whether the actual value of the log parameter or a difference of the current value to the previous value causes a smaller file size of the encoded log file; and
the coding module appends the entry that leads to the smaller file size to the encoded log file as a log entry.

This reduces the amount of storage required to store the encoded log file. A correspondingly encoded log file can then be sent more quickly via a wireless or wired network. If the log file is an aforementioned text file, for example, the coding module can particularly easily and quickly check whether the value or the difference between the current and previous value results in a smaller file size. Only the number of characters of the value or the difference needs to be compared. The value or difference that results in the smaller number of characters is then selected.

A further advantageous embodiment of the method according to the invention also provides that the coding module applies a calculation rule to a log entry to be appended to the encoded log file and appends the calculated log entry to the encoded log file. This allows the storage requirement for storing the encoded log file to be reduced even further. The calculation rule can be any formula. If the log parameter is an IP address, for example, it can be converted into a hex format using the calculation rule. This allows an IP address without dots to be reduced from 15 characters to eight characters. This procedure can be compared with the generation of hash values using a hash function. In general, every conceivable log parameter or log entry can be converted as desired. This also allows the encoded log file to be encrypted so that an attacker cannot get from the encoded log file to a decoded log file without the corresponding coding instructions.

According to a further advantageous embodiment of the method, the coding module checks the log events for the existence of a deletion event and, if a deletion event is recognized for the log parameters mentioned in the deletion event, removes all log entries relating to the respective log parameters from the encoded log file. The deletion event is a specific log event. It can be specified in the coding instructions which log events are to be regarded as deletion events and, correspondingly, which log parameters are to be removed from the encoded log file. By way of example, it can be provided that a certain number of log events are specified as a deletion event, or a certain log parameter provides a certain value. The elapsing of a predetermined time period can also represent a deletion event. In particular, a deletion event is predetermined if it can be ensured that the log parameters to be correspondingly deleted are no longer required for further analysis purposes. This allows the file size of the encoded log file to be reduced.

A further advantageous embodiment of the method also provides that a maximum size is predetermined for the encoded log file and, when the maximum size of the encoded log file is reached, the coding module starts to generate a second encoded log file after the last encoded log file has been saved or does not generate a further log file, at least for this system monitoring. The maximum size for the encoded log file can be defined in various formats, for example as a file size, for example in kilobytes, megabytes, gigabytes or similar, or also as a string length, maximum number of entries or similar. If the maximum size for the encoded log file is reached, a further encoded log file can be started from the beginning or logging can be paused or ended.

According to a further advantageous embodiment of the method according to the invention, a maximum number of log entries for a specific log parameter is predetermined for an encoded log file, wherein when the maximum number for this log parameter is reached, the respective oldest log entry is overwritten by the respective most recent log entry of the log parameter when a respective log entry is re-appended to the encoded log file. This makes it possible to keep the file size of the encoded log file constant despite ongoing logging and still record current log events. Older, in particular no longer relevant log events and corresponding log entries are then removed from the encoded log file.

In accordance with the invention, a data processing system is set up for carrying out a method described above. As already mentioned, the data processing system can be an information technology system of any design, such as an embedded system, a mobile terminal, a personal computer, a server, a quantum computer or the like. Preferably, several data processing systems can be used to implement the method according to the invention. In particular, the data processing systems are networked with one another. A data processing system can also be simulated or emulated, for example on a virtual machine.

In accordance with the invention, a vehicle comprises a data processing system as described above or a component of such a data processing system. This makes it possible to use the method according to the invention to check the system behavior of computer systems used in vehicles, for example a control unit of a vehicle subsystem.

Further advantageous embodiments of the method according to the invention for processing log files and of the data processing system emerge from the exemplary embodiments, which are described in more detail below with reference to the figures.

### BRIEF DESCRIPTION OF THE DRAWING FIGURES

Here are shown:

FIG. 1 a structure of one or more data processing systems used for carrying out a method according to the invention;

FIG. 2 a schematized representation of a mode of operation of the coding module; and

FIG. 3 a flow chart of the mode of operation of the coding module.

### DETAILED DESCRIPTION

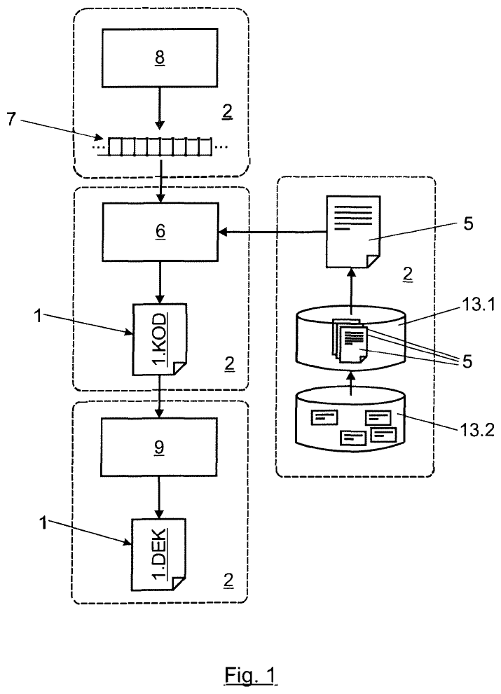

A method according to the invention describes the processing of log files 1 by means of one or more data processing systems 2. In the exemplary embodiment shown in FIG. 1, a diagnostic module 8 is integrated into a first data processing system 2, a coding module 6 is integrated into a second data processing system 2, a decoding module 9 is integrated into a third data processing system 2, and a first database 13.1 and a second database 13.2 are integrated into a fourth data processing system 2. In general, it would also be possible for all modules 8, 6, 9 and the two databases 13.1 and 13.2 to be integrated into a common data processing system 2. Any conceivable distribution of the modules 8, 6, 9 and the databases 13.1 and 13.2 to any number of data processing systems 2 is possible. The diagnostic module 8 and the coding module 6 are particularly preferably integrated into a common data processing system 2 (not represented).

The diagnostic module 8 performs system monitoring of the data processing system 2 in which it is integrated. The diagnostic module 8 then supplies a stream 7 of diagnostic data for evaluation by the coding module 6. Taking coding instructions 5 into account, the coding module 6 then generates an encoded log file 1.KOD from this stream 7 of diagnostic data. This encoded log file 1.KOD is read in by the decoding module 9 and also converted into a decoded log file 1.DEK taking into account the coding instructions 5.

The first database 13.1 can contain a plurality of differently versioned coding instructions 5. The second database 13.2 can contain coding instruction modules which can be combined to form new coding instructions 5.

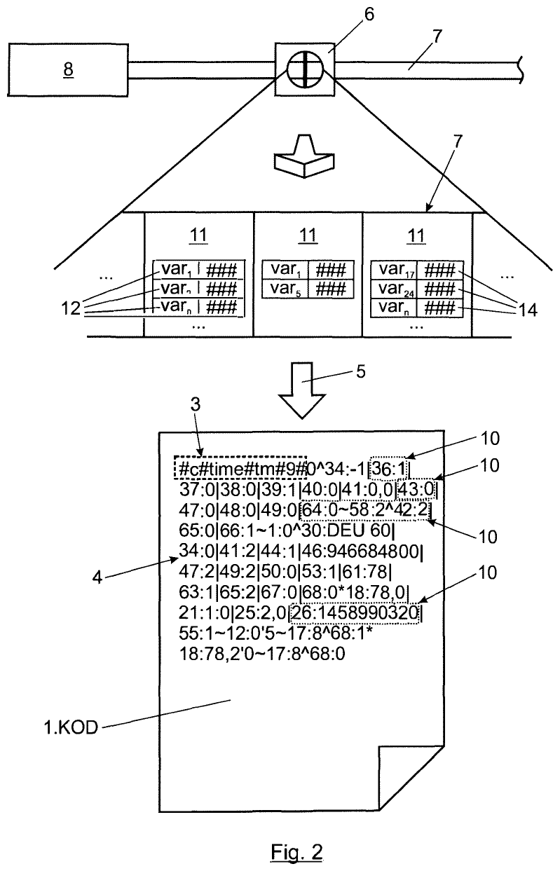

FIG. 2 symbolizes the mode of operation of the coding module 6 in a schematic representation. The coding module 6 processes the stream 7 of diagnostic data received from the diagnostic module 8. This includes, for example, status values that describe the system status of the data processing system 2 monitored by the diagnostic module 8 and/or (sensor) data recorded and/or otherwise processed by the corresponding data processing system 2. The stream 7 of diagnostic data can be understood as a sequence of log events 11, wherein each log event 11 for a respective log parameter 12 comprises a respective value 14 of the log parameter 12. Depending on the design of the hardware and/or software used, it can be provided that all existing log parameters 12 are always listed in a respective log event 11 in the stream 7 of diagnostic data, or only those log parameters 12 that indicate a changed value 14.

Taking into account the coding instructions 5, the coding module 6 converts this information into the encoded log file 1.KOD. The encoded log file 1.KOD comprises a header 3, which describes a version identifier of the coding instructions 5 used, and a payload 4, which comprises a sequence of the respectively logged log entries 10. By way of example, the encoded log file 1.KOD is a text file and therefore the header 3 and the payload 4 are a corresponding character string stored in the text file. This character string can comprise any combination of numbers, letters, special characters and mathematical symbols and the like. In order to maintain the overview, only some of the log entries 10 are provided with reference numerals. In the exemplary embodiment shown in FIG. 2, the respective log entries 10 are delimited from one another by vertical lines. In general, however, other characters or symbols could also be used or a fixed character length.

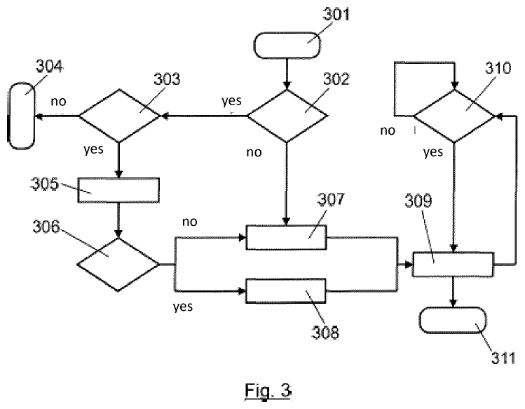

FIG. 3 shows a flow chart of the mode of operation of the coding module 6.

In a step 301, the method begins by the coding module 6 analyzing the stream 7 of diagnostic data and recognizing the presence of log events 11 with respective log parameters 12 and respective values 14.

In step 302, the coding module 6 checks iteration by iteration for each log event 11 whether a value 14 is present for the first time in the stream 7 of diagnostic data for a respective log parameter 12 or whether values 14 have already been logged. For this purpose, the coding module 6 can also read out the encoded log file 1.KOD, for example.

If this is the case, it is checked in step 303 whether the value 14 has changed from the previous value 14. If the value 14 is constant, no new log entry 10 is generated in step 304. If, on the other hand, the value 14 has changed, the difference between the two values 14 is calculated in step 305. In step 306, the coding module 6 checks whether the value 14 or the difference between the current value 14 and the respective previous value 14 causes a smaller size of the encoded log file 1.KOD, for example due to a smaller number of characters.

However, if the stream 7 of the diagnostic data for a particular log parameter 12 contains a value 14 for the first time or if the value 14 leads to a smaller file size, the value 14 is appended in step 307 as an appendix to a character string to be inserted into the encoded log file 1.KOD. If, on the other hand, the difference between the current and previous value 14 is smaller in step 308, i.e., results in a smaller file size, this difference is appended to the character string.

In step 309, the character string or information to be appended to the character string as a log entry 10 is written into the encoded log file 1.KOD. The encoded log file 1.KOD is then saved. In addition, a timer runs, wherein it is checked in step 310 whether the timer has run out. If this is the case, step 309 is carried out again. As no new characters have been added to the character string of the encoded log file 1.KOD, only the encoded log file 1.KOD is then saved again.

In step 311, the encoded log file 1.KOD can be accessed for analysis. For this purpose, the encoded log file 1.KOD is decoded by the decoding module 9.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-11 (canceled)

12. A method for processing log files with computer-aided data processing systems, the method comprising:
reading coding instructions into a coding module;
performing system monitoring and generating a stream of diagnostic data using a diagnostic module during the system monitoring;
reading the stream of diagnostic data into a coding module;
generating an encoded log file by applying the coding instructions to the stream of diagnostic data through the coding module, wherein the coding module assigns a version identifier of the coding instructions to a header of the encoded log file, wherein the coding module appends a log entry as a payload to the encoded log file responsive to the coding module recognizing, in the diagnostic data, a log event affecting a particular log parameter for a first time or that describing a change in the particular log parameter;
reading the encoded log file into a decoding module;
reading the coding instructions into the decoding module; and
generating a decoded log file accounting for the coding instructions from the encoded log file through the decoding module,
wherein the coding module causes the encoded log file to be saved in a current state during the system monitoring responsive to the coding module having appended a log entry to the encoded log file or responsive to a predefined period of time elapsing without appending a further log entry, and
wherein the encoded log file is generated, processed, or at least temporarily stored by the computer-aided data processing system in an encoded format.

13. The method of claim 12, further comprising:
at least temporarily storing a first encoded log file in the computer-aided data processing system after the first encoded log file is generated during a first system monitoring; and
concatenating, by the coding module, the first encoded log file with a second encoded log file when generating the second encoded log file during a second system monitoring.

14. The method of claim 12, wherein a plurality of differently versioned coding instructions are stored in a first database.

15. The method of claim 14, wherein a plurality of coding instruction modules are stored in a second database, wherein the computer-aided data processing system reads at least two coding instruction modules from the second database and combines the at least two coding instruction modules to generate a coding instruction.

16. The method of claim 12, wherein
when a specific log parameter is mentioned for a first time by a log event, the coding module appends a value of the specific log parameter described by the diagnostic data to the encoded log file as a log entry,
before each further appending of a log entry concerning the specific log parameter, the coding module checks whether an actual value of the specific log parameter or a difference of a current value to a previous value results in a smaller file size of the encoded log file, and
the coding module appends an entry leading to the smaller file size to the encoded log file as a further log entry.

17. The method of claim 12, wherein the coding module applies a calculation rule to a log entry to be appended to the encoded log file and appends the calculated log entry to the encoded log file.

18. The method of claim 12, wherein the coding module checks the log events for existence of a deletion event and, if the deletion event is recognized for log parameters mentioned in the deletion event, the coding module removes all the log entries relating to the respective log parameters from the encoded log file.

19. The method of claim 12, wherein a maximum size is predetermined for the encoded log file and, when the maximum size of the encoded log file is reached, the coding module starts to generate a second encoded log file after a last encoded log file has been saved or does not generate a further log file, at least for this system monitoring.

20. The method of claim 12, wherein a maximum number of log entries for a specific log parameter is predetermined for an encoded log file, wherein when the maximum number for this log parameter is reached, a respective oldest log entry is overwritten by the respective most recent log entry of the log parameter when a respective log entry is re-appended to the encoded log file.

21. A data processing system configured to
read coding instructions into a coding module;
perform system monitoring and generating a stream of diagnostic data using a diagnostic module during the system monitoring;
read the stream of diagnostic data into a coding module;
generate an encoded log file by applying the coding instructions to the stream of diagnostic data through the coding module, wherein the coding module assigns a version identifier of the coding instructions to a header of the encoded log file, wherein the coding module appends a log entry as a payload to the encoded log file responsive to the coding module recognizing, in the diagnostic data, a log event affecting a particular log parameter for a first time or that describing a change in the particular log parameter;
read the encoded log file into a decoding module;
read the coding instructions into the decoding module; and
generate a decoded log file accounting for the coding instructions from the encoded log file through the decoding module,
wherein the coding module causes the encoded log file to be saved in a current state during the system monitoring responsive to the coding module having appended a log entry to the encoded log file or responsive to a predefined period of time elapsing without appending a further log entry, and
wherein the encoded log file is generated, processed, or at least temporarily stored by the data processing system in an encoded format.

22. The data processing system of claim 21, wherein the data processing system or a component of the data processing system is part of a vehicle.
